(19) United States
(12) Patent Application Publication
(10) Pub. No.: US 2021/0080598 A1
(43) Pub. Date: Mar. 18, 2021

(54) METHOD FOR ACQUIRING A SEISMIC DATASET OVER A REGION OF INTEREST AND RELATED SYSTEM

(71) Applicant: TOTAL SA, COURBEVOIE (FR)

(72) Inventors: Frank ADLER, PAU (FR); Jean-Luc BOELLE, PAU CEDEX (FR); Henri PUNTOUS, PAU (FR); Isabella MASONI, PAU CEDEX (FR); Peigen XIE, PAU (FR)

(73) Assignee: TOTAL SA, COURBEVOIE (FR)

(21) Appl. No.: 16/620,393

(22) PCT Filed: Jun. 7, 2018
(86) PCT No.: PCT/EP2018/065067

§ 371 Date: Dec. 6, 2019

(30) Foreign Application Priority Data
Jun. 8, 2017 (EP) 17305683.9

(51) Int. Cl. G01V 1/00; G01V 1/34

(52) U.S. Cl. CPC G01V 1/003; G01V 1/345; G01V 2210/1425; G01V 2210/1295; G01V 2210/16

(57) ABSTRACT

The method acquiring a ground seismic dataset over a region of interest by defining a geometry of acquisition of the seismic dataset specifying a location of a plurality of seismic sources and a location of a plurality of seismic receivers, inducing a seismic signal with at least one first seismic source of the plurality of seismic sources, and measuring the corresponding ground vibrations induced by the at least one first seismic source with the plurality of seismic receivers to obtain a first seismic dataset. Then processing the first seismic dataset and modifying the geometry of acquisition of the first seismic dataset by specifying a location of at least an additional seismic source and/or a location of at least an additional seismic receiver, based on analyzing the processed first seismic dataset.

### CROSS REFERENCE TO RELATED APPLICATIONS

This is a U.S. National Phase Application under 36 U.S.C. § 371 of International Patent Application No. PCT/EP2018/065067, filed Jun. 7, 2018, which claims priority of European Patent Application No. 17305683.9, filed Jun. 8, 2017. The entire contents of which are hereby incorporated by reference.

### FIELD OF THE INVENTION

The present invention concerns a method for acquiring a seismic dataset over a region of interest.

The region of interest is notably a region with a difficult access. The region in particular comprises a high density of vegetation, such as a forest, such as a tropical forest. Also, the region may comprise rugged terrain such as hills (for example foothills), cliffs and/or mountains. Also, the region may comprise dangerous to access areas, such as areas with unexploded ordinances (UXOs).

The method can also be applied to any region of interest.

### BACKGROUND

The seismic survey acquisition is one of the main geophysical methods carried out for exploration in oil and gas industry. The geophysical measurements obtained during such a survey are critical in building a subsurface image representative of the geology of the region of interest, in particular to determine the location of potential reservoirs of oil and gas.

Such seismic survey is for example conducted by deploying seismic sources and seismic receivers, such as geophones, on the ground of the region of interest. The seismic receivers are able to record mainly the reflections of the seismic waves produced by the seismic sources on the different layers of the earth in order to build an image of the subsurface.

The seismic survey generally requires seismic sources and a large amount of seismic receivers on the ground at various locations, along generally several profiles to create dense arrays of seismic sources and seismic receivers.

The quality of the subsurface image obtained after the processing of the seismic survey data is generally a function of the surface density of seismic sources and/or of seismic receivers. In particular, a significant number of seismic receivers have to be put in place on the ground to obtain an image of good quality. This is in particular the case when a three-dimensional image is required.

Placing seismic sources and seismic receivers in a remote region of interest may be a tedious, dangerous and expensive process. In particular, when the region is barely accessible, such as in a tropical forest and/or in a region with uneven terrain and/or in a region with UXOs, the seismic sources and the seismic receivers have to be carried at least partially by foot by teams of operators. In many cases, clearings have to be opened in the forest to place on the ground the relevant equipment and operators. Trails must then be cleared in the forest to deploy the seismic receivers.

These tasks create a strong environmental impact in the region of interest and may induce significant health and safety risks for the operators, especially during the setting-up of the seismic receivers and of the seismic sources.

The set-up of the seismic receivers and/or the seismic sources on the ground is an extensive process which requires drilling the ground, and in the case of the seismic receivers, ensuring that the coupling between the seismic receiver and the ground is adequate.

A way for setting up the seismic receivers consists in using a flying vehicle such as an unmanned aerial vehicle. The flying vehicle is flown above the location at which the seismic receiver should be implanted in a dropping area. Then, the seismic receivers are successively dropped from the flying vehicle and fall to the ground.

The setting up of the seismic receivers may also be made using other methods.

The geometry of acquisition, i.e. the density of seismic sources and seismic receivers and their relative locations in the area of interest, is generally defined before the beginning of the survey.

The geometry of acquisition is for example based on empirical rules depending on the targeted depth of exploration. In a variant, the geometry of acquisition is based on modelling using the available geological and geophysical data in the area of interest.

However, for such complex geological area with rugged topography such as described above, the results obtained at the end of the survey, after the processing of the seismic dataset, may lead to an image of the subsurface having a lesser quality than expected.

### SUMMARY

One aim of the invention it to provide an efficient method for acquiring a seismic dataset which provides a good quality image of the subsurface even in terrains with rugged topography and/or dense vegetation.

To this aim, the subject-matter of the invention is a method for acquiring a seismic dataset over a region of interest, said method comprises:

defining a geometry of acquisition of the seismic dataset specifying a location of a plurality of seismic sources and a location of a plurality of seismic receivers,

inducing a seismic signal with at least one first seismic source of the plurality of seismic sources,

measuring the corresponding ground vibrations induced by the at least one first seismic source with the plurality of seismic receivers to obtain a first seismic dataset,

processing the first seismic dataset,

modifying the geometry of acquisition of the first seismic dataset by specifying a location of at least an additional seismic source and/or a location of at least an additional seismic receiver, based on analyzing the processed first seismic dataset.

The method according to the invention may comprise one or more of the following features, taken solely or according to any potential technical combination:

the processing step comprises calculating a quality index based on a quality control of the first seismic dataset and/or obtaining at least a basic image of the underground of the region of interest with an seismic imaging algorithm using the processed first seismic dataset,

the seismic imaging algorithm is a pre-stack time migration algorithm or a pre-stack depth migration,

the method further comprises:
placing the additional seismic source at the specified location,
inducing a seismic signal with the additional seismic source,
measuring the corresponding ground vibrations with the plurality of seismic receivers to obtain at least one second seismic dataset,

the method further comprises:
placing the additional seismic receiver at the specified location,
inducing a seismic signal with a seismic source,
measuring the corresponding ground vibrations with a plurality of seismic receivers including the additional seismic receiver to obtain a second seismic dataset,

the method comprises processing the first seismic dataset and the at least one second dataset together to obtain at least a updated processed image of the underground of the region of interest,

the step of processing the first seismic dataset and/or the second seismic dataset is carried out before the demobilization of the seismic survey, preferably before inducing a seismic signal with the last seismic source of the survey,

the first seismic dataset and the or each second seismic dataset are merged into a global dataset, the method further comprising processing the global dataset after the demobilization,

the global dataset is processed using a full waveform inversion algorithm for obtaining a global image of the underground of the region of interest,

the step of processing the first seismic dataset and/or the second seismic dataset is carried out in a characteristic time delay after having induced a seismic signal with the last seismic source of the corresponding first and/or second dataset, the characteristic time delay being preferably less than one week, still preferably less than one day, still preferably less than six hours, still preferably less than one hour,

the method comprises, prior to the processing step, inducing a seismic signal with at least a second seismic source of the plurality of seismic sources and measuring the corresponding ground vibrations induced by the at least second seismic source with the plurality of seismic receivers of the plurality of receivers, the first dataset including data measured from the ground vibrations induced by the first seismic source and induced by the second seismic source,

the method further comprises transmitting in real-time the ground vibrations measurements to a base camp located in the region of interest, using at least one communication antenna installed in the region of interest,

the method comprises transporting the at least one additional seismic receiver at their respective specified location using an airborne vehicle.

The invention also concerns a system for acquiring a seismic dataset over a region of interest comprising:
a location defining unit for defining a geometry of acquisition of a seismic dataset by specifying a location of a plurality of seismic sources configured to induce a seismic signal in the ground, and by specifying a location of a plurality of seismic receivers configured to measure ground vibrations induced by the seismic sources,
a seismic signal inducing unit for inducing a seismic signal with at least one first seismic source of the plurality of seismic sources,
a measuring unit for receiving measurements of the corresponding ground vibrations induced by the at least one first seismic source with the plurality of seismic receivers to obtain a seismic dataset,
a processing unit for processing the seismic dataset,
a unit for modifying the geometry of acquisition of the seismic dataset by specifying a location of at least an additional seismic source and/or a location of at least an additional seismic receiver, based on analyzing the processed seismic dataset.

The system according to the invention may comprise one or more of the following features, taken solely or according to any potential technical combination:

the processing unit comprises a quality index calculating subunit for calculating quality index based on a quality control of the first dataset, and/or an imaging subunit for obtaining at least a basic image of the underground of the region of interest with an seismic imaging algorithm,

the system further comprises a real-time transmitting unit for transmitting the ground vibrations measurements to a base camp located in the region of interest, using at least one communication antenna installed in the region of interest,

the processing unit is configured for carrying out the processing of the seismic dataset in a characteristic time delay after having induced a seismic signal with the last seismic source of the seismic dataset, the characteristic time delay being preferably less than one week, still preferably less than one day, still preferably less than six hours, still preferably less than one hour.

The invention is also related to a computer program product comprising instructions, which when the program is executed by a computer, implements the following steps:

defining a geometry of acquisition of the seismic dataset specifying a location of a plurality of seismic sources and a location of a plurality of seismic receivers,

acquiring a first seismic dataset obtained from measuring ground vibrations induced by at least one first seismic source with a plurality of seismic receivers, the seismic source inducing a seismic signal,

processing the first seismic dataset, preferably by calculating a quality index based on a quality control of the first seismic dataset and/or obtaining at least a basic image of the underground of the region of interest with a seismic imaging algorithm using the processed first seismic dataset;

modifying the geometry of acquisition of the first seismic dataset by specifying a location of at least an additional seismic source and/or a location of at least an additional seismic receiver, based on analyzing the processed first seismic dataset.

The defining step and/or the modifying steps can be carried out based on defining data and/or modifying data which are input by a user.

The computer program product advantageously comprises instructions, which when the program is executed by a computer, implements one or more steps of the method defined above, solely, or according to any technical combination.

Advantageously, the computer program product comprises program code to one way or two-way transfer, the raw seismic dataset and/or the quality control processed seismic dataset and/or the preprocessed seismic dataset between a first processing unit located in the region of interest or in the vicinity of the region of interest, and a second processing unit located remotely from the region of interest or the vicinity of the region of interest.

### BRIEF DESCRIPTION OF THE DRAWINGS

The invention will be better understood, based on the following description, given solely as an example, and made in reference to the following drawings, in which:

FIG. 1 is a schematic geographical view of a region of interest in which a seismic dataset is acquired by the method according to the invention;

FIG. 2 is a schematic three-dimensional view of a part of the region of interest of FIG. 1,

FIG. 3 is a flow chart of a method for acquiring a seismic dataset over a region of interest, according to the invention;

FIG. 4 is a schematic representation of an example of a processing step of a seismic dataset of the method according to the invention,

FIG. 5 is a flow chart of a preprocessing step and an imaging step of the method according to the invention, and

FIG. 6 is a schematic representation of a system for acquiring a seismic dataset over a region of interest, according to the invention.

### DETAILED DESCRIPTION

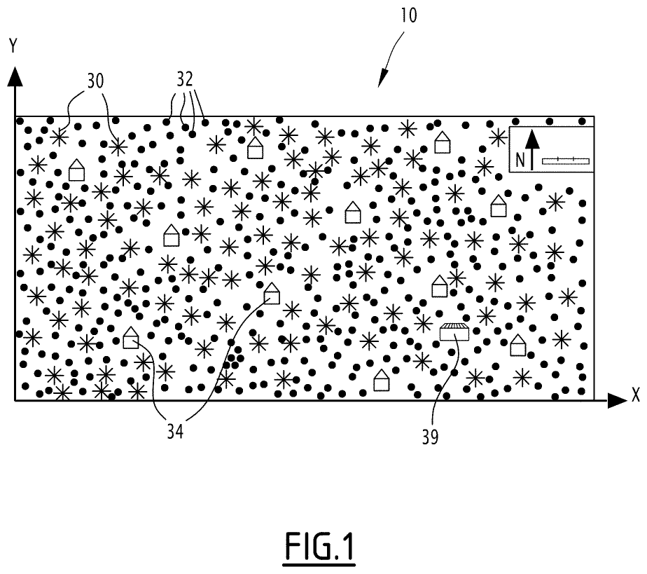

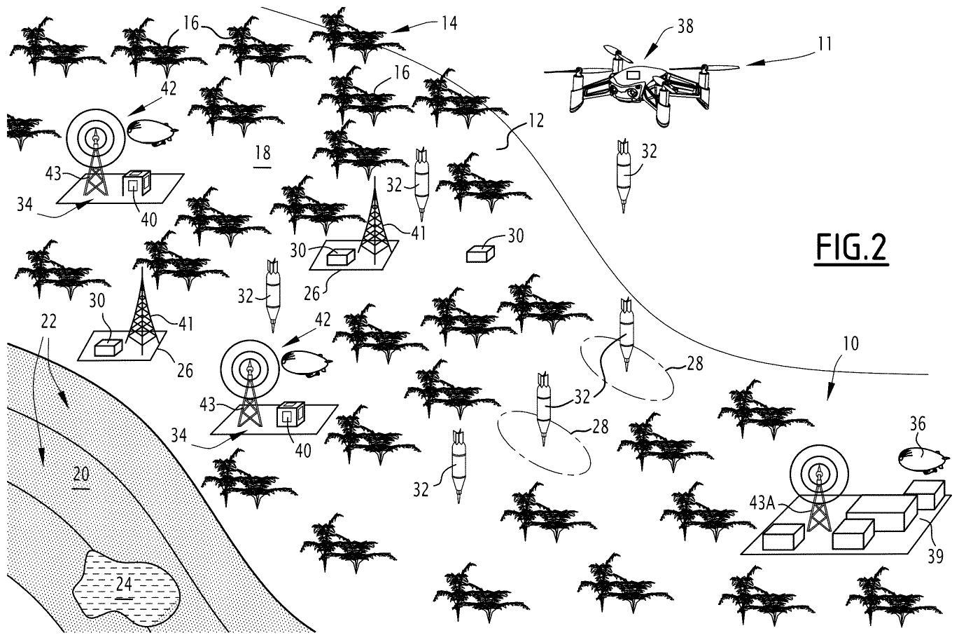

FIG. 1 and FIG. 2 show respectively a schematic geographical map of projected coordinates of a region of interest 10 where a seismic survey acquisition is carried out and a three dimensional view of a part of the region of interest 10.

The region of interest 10 is for example a region having an uneven terrain 12. The uneven terrain 12 in particular comprises hills, mountains, cliffs or any type of rugged terrain. The region of interest 10 is for example located on foothills which are difficult to access.

The region of interest 10 further comprises vegetation 14. The vegetation 14 is for example a forest, in particular a tropical forest. It comprises a high density of vegetation 14, for example trees 16 forming a canopy 18 which covers a majority of the surface of the ground in the region of interest 10.

The subsurface 20 located below the ground comprises layers of geological formation 22 and potentially oil and gas reservoirs 24.

In the region of interest 10, the vegetation 14 defines a plurality of natural and/or artificial clearings 26. The vegetation 14 in the region of interest 10 also defines sky holes 28 in the canopy 18.

The clearings 26 are spread in the region of interest 10, at a distance generally comprised between 100 m and 500 m, preferentially 300 m taken along the line of sight between two adjacent clearings.

The clearings 26 generally have a surface area greater than 25 m² at the ground level and generally greater than 900 m² at the top of the canopy 18. The seismic sources 30 can be put in place in the clearings 26.

A clearing 26 is for example defined in a OGP Standard “OGP-Helicopter Guideline for Land Seismic and Helirig operations—Report 420 version 1.1 June 2013.

Sky holes 28 are generally natural. They advantageously form a vertical “light tube” between the canopy 18 and the ground.

For example, the sky holes 28 have a minimal surface area greater than 1 m², preferentially greater than 3 m², and comprised for example between 3 m² and 20 m².

At least a sky hole 28 has a surface area which is smaller than the surface area of the clearings 26.

The seismic survey is a geophysical survey which comprises collecting geophysical measurements for determining physical properties of the subsurface 20 located in the region of interest 10 and/or for building an image of the subsurface 20, preferably a tridimensional image of the subsurface 20 based on the processing the collected measurements.

The physical properties are typically the density and/or the wave velocities of the layers of geological formation 22.

The seismic dataset is acquired with a plurality of seismic sources 30 and a plurality of seismic receivers 32 placed in the region of interest 10.

Each seismic source 30 is able to generate waves which propagate in the subsurface 20 and reflect at the interfaces of the layers of geological formation 22.

The seismic source 30 for example comprises an explosive, in particular dynamite, able to generate waves in the ground.

The seismic source 30 is typically inserted in a hole drilled into the ground, for example at a depth comprised between 0 meter and 100 meters, preferably between 5 meters and 80 meters.

For example, the hole is drilled using a unmanned ground vehicle such as a semi-automatic drilling platform.

In a variant, the seismic source 30 comprises a mechanical device such as a hammer, a vibrator . . .

The density of source 30 locations laid in the region of interest 10 is generally comprised between 10 source locations per km² and 100 source location per km². Each source location can comprise one or more source 30.

Each source 30 is preferably arranged in a clearing 26. The source 30 is generally brought to the clearing 26 by the additional flying vehicle 36.

In the example of FIG. 2, each seismic source 30 is preferably arranged in a clearing 26.

Advantageously, several seismic sources 30 are arranged in a clearing 26. Each seismic source 30 is preferably carried at their locations without a ground vehicle from a base camp 34.

For example, at least a part of the seismic source 30 is carried at its location using an airborne vehicle 36 such as an airship or a helicopter.

In a variant or in addition, at least a part of the seismic source 30 is carried at its location by foot by a team of operators.

Each seismic receiver 32 is able to record the waves generated by each seismic source 30 and the reflected waves at the interfaces of the layers of geological formation 22.

The seismic receiver 32 is for example a geophone able to measure the velocity of the direct and reflected waves.

Advantageously, the seismic receiver 32 comprises at least one geophone, in particular three geophones and/or an accelerometer.

Each seismic receiver 32 is partially introduced in the ground so as to ensure a good coupling with the ground.

In the example of FIG. 2, the seismic receivers 32 are transported to their locations and dropped in the ground from airborne platforms 38.

The airborne platforms 38 typically take off from a base camp 34.

For example, the airborne platform 38 is a UAV (for Unmanned Aerial Vehicle).

Each seismic receiver 32 has for example the shape of a dart adapted to be introduced in the ground. In a variant, the seismic receiver 32 has the shape of a ball or/and a parallel pipe shape.

The seismic sources 30 and/or the seismic receivers 32 are for example transported to the base camp 34 using a vehicle such as a ground vehicle, e.g. a truck, an unmanned ground vehicle (UGV) or an airborne vehicle, e.g. a helicopter.

Typically, the density of seismic receivers 32 is for example between 10 seismic receivers 32 per km² and 1000 seismic receivers 32 per km², in particular between 300 seismic receivers 32 per km² and 500 seismic receivers 32 per km², notably 400 seismic receivers 32 per km².

A base camp 34 comprises for example facilities adapted to house operators during the seismic survey and equipment for the seismic survey. The base camp 34 comprises a helipad and is typically used for management of the take-off and the landing.

The base camp 34 may be used for first aid (e.g. medevac).

Typically, the area of interest 10 comprises a plurality of base camps 34 spread in the whole surface of the area of interest 10.

Each base camp 34 typically comprises a collection and/or analysis unit 40 and a telecommunication system 42 able to transfer data measured by the seismic receivers 32 to the collection and/or analysis unit 40 and from the collection and/or analysis unit 40 to an external station 43A.

For example, the telecommunication system 42 comprises at least one antenna 41 installed next to a seismic source 30 and at least one antenna 43 installed in each base camp 34.

Typically, each seismic receiver 32 comprises an internal antenna able to communicate with at least one of the antenna 41 installed next to the seismic sources 30.

The external station 43A may be located at a main camp 39. The main camp 39 advantageously comprises facilities for collecting data, as well as a main computing unit, and/or a control center.

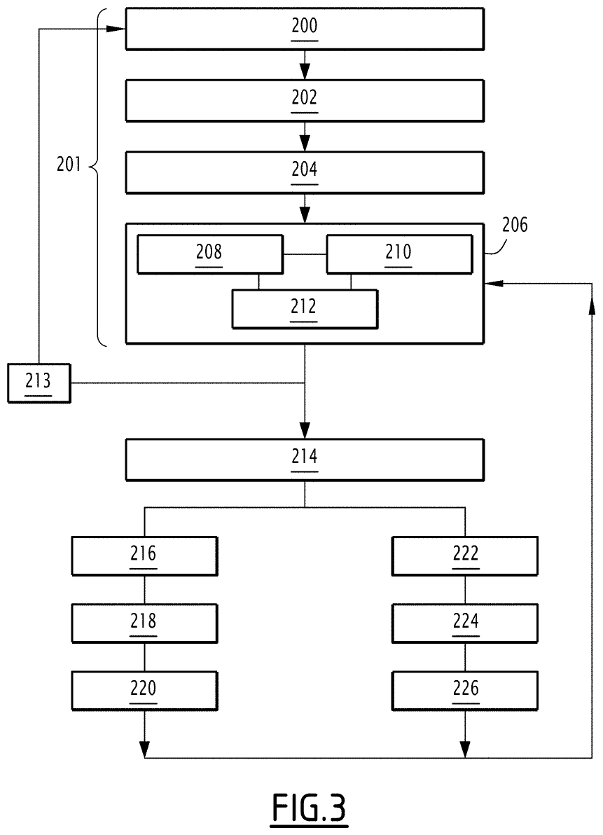

As presented in FIG. 3, the method according to the invention comprises a step 200 for defining an initial geometry of acquisition of the seismic dataset specifying a location of a plurality of seismic sources 30 and a location of a plurality of seismic receivers 32 over the region of interest 10 and for placing the sources 30 and the receivers 32 at their respective locations.

The method then comprises a succession of recording phases 201, in which the sources 30 are successively activated to induce a seismic signal which is measured by the plurality of receivers 32.

Advantageously, the method comprises a characterization phase of the region of interest 10 prior the first recording phase.

Typically, the characterization phase comprises positioning additional sensors in the clearings 26 to measure at least a physical parameter of the ground.

For example, the additional sensors are magneto-telluric sensors and the characterization phase further comprises calculating a large-scale electrical conductivity model based on the magneto-telluric measurements provided by said magneto-telluric sensors.

Magneto-telluric sensors measure the natural geomagnetic and geoelectric field variation on the surface of the ground.

The depth of investigation of the magneto-telluric method ranges from several hundred meters below ground, for example 300 m to several kilometers, for example 5 km, depending on the frequencies of the measured signals and the corresponding measuring periods.

The large-scale electrical conductivity model is typically used during the processing of the seismic dataset as a priori information.

For example, the additional sensors are geophones installed in the clearings 26.

The characterization phase then comprises analyzing the ground vibrations induced by the drilling tool during the setting-up of the sources 30 to determine a physical parameter of the subsurface 20.

The analysis is for example an ambient passive seismic imaging technique known from the prior art.

For example, the determined physical parameter of the subsurface 20 is the S-wave velocity variations with depth and/or the P-wave velocity variations with depth.

Advantageously, the determined physical parameter is used to build a velocity model which is used for the processing of the seismic dataset as a large-scale first order starting model, as described below.

Each recording phase 201 comprises a step 202 for inducing a seismic signal with at least one first seismic source 30 of the plurality of seismic sources 30.

Moreover, each recording phase 201 comprises a step 204 for measuring the corresponding ground vibrations induced by the at least one first seismic source 30 with the plurality of seismic receivers 32 over the region of interest 10 to obtain a first seismic dataset.

Each recording phase 201 comprises transmitting in real-time, preferably after each seismic signal has been induced, the ground vibrations measurements to a base camp 34 located in the region of interest 10, using the telecommunication system 42.

In a next step, each recording phase 201 comprises a step 206 for processing the first seismic dataset (FIG. 3).

Typically, the method comprises grouping the measurements recorded by the plurality of receivers 32 after each seismic source 30 has induced a seismic signal to form a plurality of common shot gathers (CSG), each corresponding to a seismic signal induced with a specific source 30 in the first seismic dataset.

Typically, the processing step 206 comprises a quality control (QC) step 208, advantageously applied to each common shot gather.

The QC step 208 comprises for example identifying improper measurements of the first seismic dataset and removing corrupted measurements.

Typically, the improper measurements comprise measurements obtained from one or more malfunctioning seismic receivers 32, such as dead, weak, noisy and/or spiky seismic receivers 32. A QC processed first seismic dataset is obtained.

Advantageously, the QC step 208 comprises calculating a quality index based on a quality control of the first seismic dataset.

For example, the quality index comprises an average frequency content, a dominant frequency content, and/or a root mean square (RMS) amplitude.

In addition, the QC step 208 may comprise checking the consistency of the recorded locations of the plurality of seismic sources 30 and of the plurality of seismic receivers 32.

The processing step 206 then comprises a pre-processing step 210 to obtain a pre-processed first seismic dataset.

The pre-processing step 210 comprises carrying out corrective actions on the QC processed first seismic dataset.

Typically, the pre-processing step 210 comprises classical steps of seismic pre-processing known from the prior art, such as data re-sampling, static correction, noise attenuation, deconvolution, equalization, etc.

Typically, the pre-processing step 210 comprises separating the signal contained in the seismic dataset such as noise filtering.

The pre-processing step 210 may comprise time corrections and/or amplitude corrections to take into account the specificities of the source 30 and/or the receiver 32 and/or the near surface geology.

The pre-processing step 210 may also comprise interpolating data on a new grid with a different grid cell size (regularization).

Typically, the pre-processing step 210 also comprises reformatting the seismic dataset.

The pre-processing step 210 is for example performed in the field, advantageously in the main camp 39.

In a variant, the pre-processing step 210 is performed in a data processing center located out of the area of interest 10.

The processing step 206 then comprises an imaging step 212 for obtaining at least a basic image for each shot record of the underground of the region of interest 10 with at least one seismic imaging algorithm, based on the pre-processed first seismic dataset.

Typically, the processing step 206 comprises using the first-order velocity model obtained during the characterization phase.

For example, the seismic imaging algorithm is a pre-stack time migration (PSTM) algorithm.

A pre-stack time migration is an imaging seismic algorithm which allows focusing and geometrically re-locating seismic reflections above their subsurface locations and thus obtaining an image of the subsurface in time domain. The PSTM is applied to each shot record.

For example, the pre-stack time migration algorithm is based on a Kirchhoff scheme using an explicit time/offset relationship. The algorithm typically requires a time migration velocity field, estimated as the average velocity between surface and point to be imaged, which fits the time offset response of reflected event.

Algorithms details may for example be found in “Fundamental of Geophysical Data Processing”, Claerbout, Stanford University, 1976, Mc Graw-Hill, “Imaging the Earth's interior”, Claerbout, Stanford University, 1984, Blackwell Scientific Publications or “Seismic Migration (1st edition), Imaging of Acoustic Energy by Wave Field extrapolation”, Berkhout, 1980, Elsevier.

Typically, PSTM images are generated using very simple velocity models of the subsurface obtained for example from migration velocity analysis methods known in the prior art.

In a variant or in addition, the seismic imaging algorithm is a pre stack depth migration algorithm (PSDM) applied to each shot record. PSDM requires a velocity-depth model. A simple initial velocity-depth model can be obtained from first arrival inversion methods known in the prior art.

For example, the pre stack depth migration algorithm is based either on a Kirchhoff scheme or on a Reverse Time Migration (RTM).

The Kirchhoff scheme then requires a depth velocity model and an explicit computation of transit time between surface and subsurface points to image (also known as Green function). A first depth model can be estimated thanks to First break tomography (or Full Waveform inversion) and/or correlation with multi-physics data (resistivity from Magneto-tellurics). The Kirchhoff scheme might be advantageously used to update the migration velocity field.

In the Reverse Time Migration, measured data are back propagated from seismic receivers and cross-correlated with a propagated wave field from source point to build the image. A potential technology is detailed for example in the patent application PCT/EP2016/057136 of the Applicant. This technology can for example be used to create migrated gathers from RTM and update the migration velocity field.

Other details relative to the Reverse Time Migration may be found in “Reverse time migration”, E. Baysal, D. Kosloff, J. W. C. Sherwood, 1983, Geophysics, Vol 48(11), pp. 1514-1524, or in “Elastic reverse Time Migration”, W. F. Chang, G. A. McMechan, 1987, geophysics, Vol 52(10), pp 1365-1375.

In addition, other geophysical information from additional geophysical surveys/measurements may be used to build the simple velocity models, such as well log measurements on core samples, passive seismic methods, etc.

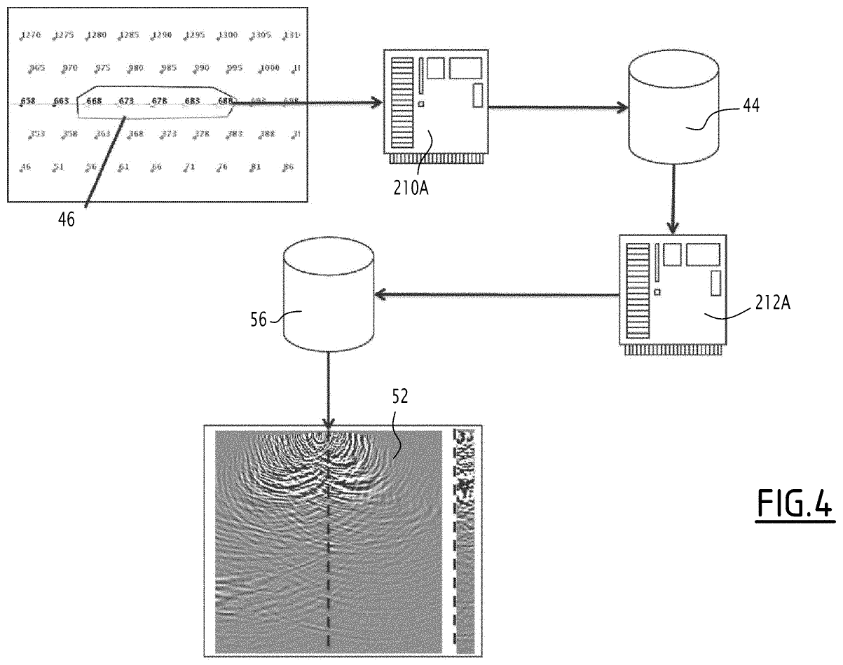

FIG. 4 shows an example of processing step 206A comprising a pre-processing step 210A and an imaging step 212A.

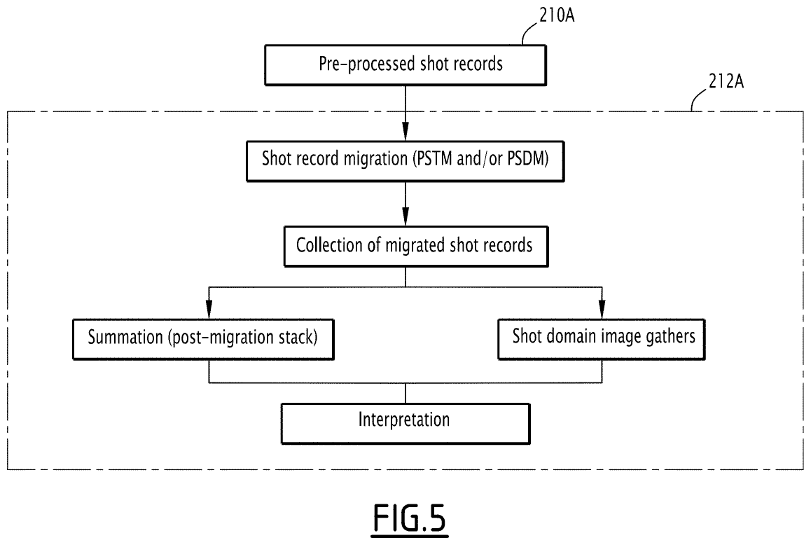

FIG. 5 depicts an example of the successive steps of an imaging step 212A.

Typically, each acquired common shot gather is immediately pre-processed and stored on a first disk space 44. The pre-processing 210A is typically implemented progressively during the acquisition of the survey.

The pre-processed common shot gathers 46 are further processed with an imaging algorithm such as a PSTM and/PSDM imaging algorithm and corresponding processed images 52 are stored on disk 56 and are displayed.

Typically, the processed and PSTM and/or PSDM migrated common shot gathers are then retrieved easily by a geologist/geophysicist in charge of the processing if required during the acquisition of the survey.

Typically, as seen in FIG. 5, the PSTM and/or PSDM migrated shot records are collected and prepared for interpretation and quality control in two ways: (i) display of individual migrated shot records or a sum of migrated shot records (post-migration stack) providing a subsurface image, (ii) display of selected neighboring migrated shot records at a selected surface position as a function of the shot index (shot domain image gathers).

Typically, the processing step 206 comprises processing the seismic dataset in parallel with several imaging algorithms.

For example, the processing step 206 comprises independently processing the common shot gathers progressively after each acquisition, i.e. after each shot, with a first imaging algorithm such as a PSTM imaging algorithm, as described above with FIG. 4, in order to obtain an image before the end of the survey and preferably, after each shot and/or at the end of each recording phase 201.

Advantageously, the step of processing the first seismic dataset is carried out before the end of the survey, in a characteristic time delay after having induced a seismic signal with the last seismic source 30 of the corresponding recording phase 201.

For example, the characteristic time delay is preferably less than one week, still preferably less than one day, still preferably less than six hours, still preferably less than one hour.

Typically, the characteristic time delay is dependent on the sub-steps of the processing step 206.

For example, the characteristic time delay depends on the imaging algorithm used during the imaging step 212.

The characteristic time delay may also depend on the size of the first seismic dataset.

The step of processing the first seismic dataset is carried out before the demobilization of the seismic survey, preferably before inducing a seismic signal with the last seismic source of the survey.

The processing step also comprises processing in parallel the seismic dataset with a second imaging algorithm, such as a PSDM imaging algorithm in order to obtain a more precise image of the subsurface 20 at the end of the survey 213 after all the shots have been fired, at the end of the last recording phase 201.

Typically, the first imaging algorithm is a fast algorithm which does not require high computing resources and the second imaging algorithm is an algorithm which requires higher computing resources.

For example, the results obtained with the first imaging algorithm are used as a priori information for the second imaging algorithm.

For example, the velocity model of the area of interest is updated progressively during the processing of the seismic dataset.

According to the invention, at the end of a recording phase 201, the method comprises a step 214 for modifying the geometry of acquisition of the first seismic dataset by specifying a location of at least an additional seismic source 30 and/or a location of at least an additional seismic receiver 32, based on analyzing the processed first seismic dataset and the images of subsurface obtained during the processing step 206.

Typically, the analysis of the first seismic dataset is based on the interpretation by the geologist and/or the geophysicist of the images of the subsurface obtained during imaging step 212 and/or the calculated quality index obtained during the processing step 206.

Advantageously, the interpretation step comprises analyzing other available geological and/or geophysical data on the region of interest 10 such as data from additional ground or airborne geophysical data.

The specification of the location of the at least one additional seismic source 30 and/or seismic receiver 32 is for example determined by the geologist and/or the geophysicist.

In a variant or in addition, the location of the at least one additional seismic source 30 and/or seismic receiver 32 is determined or confirmed by modelling.

The method then comprises a step 216 for placing the additional seismic source 30 at the specified location, a step 218 for inducing a seismic signal with the additional seismic source 30 and a step 220 for measuring the corresponding ground vibrations with the plurality of seismic receivers 32 to obtain a second seismic dataset.

In a variant or in addition, the method also comprises a step 222 for placing the additional seismic receiver 32 at the specified location, a step 224 for inducing a seismic signal with a seismic source 30 and a step 226 for measuring the corresponding ground vibrations with a plurality of seismic receivers 32 including the additional seismic receiver 32 to obtain the second seismic dataset.

Typically, the additional seismic sources 30 and/or seismic receivers 32 comprise replacement seismic sources 30 and/or seismic receivers 32 to replace the seismic sources 30 and/or seismic receivers 32 of the initial geometry of acquisition which do not work well during the acquisition of the first seismic dataset, for example due to a poor coupling with the ground, electronic or transmission problems. In this case, the additional seismic sources 30 and/or seismic receivers 32 are typically placed in the vicinity of the seismic sources 30 and/or the seismic receivers 32 of the initial geometry of acquisition, for example at less than 5 m from the bad seismic sources 30 and/or at less than 20 m from the bad seismic receivers 32.

The additional seismic sources 30 and/or seismic receivers 32 comprise also seismic sources 30 and seismic receivers 32 located in zones of the area of interest 10 wherein the recorded seismic signals with the initial geometry of acquisition are weak due to a complex geology and/or topography.

The additional seismic sources 30 and/or seismic receivers 32 are typically installed in the area of interest 10 similarly to the seismic sources 30 and/or the seismic receivers 32 belonging to the initial geometry of acquisition, as described above.

Advantageously, the method comprises processing the first seismic dataset and the or each second dataset together to obtain at least an updated processed image of the underground of the region of interest 10.

Advantageously, the step of processing the second seismic dataset and/or the combination of the first seismic dataset and of the second seismic dataset is carried out before the end of the survey, in the characteristic time delay defined above.

Advantageously, the step of processing the first seismic dataset and/or the second seismic dataset is carried out before the demobilization of the seismic survey, preferably before inducing a seismic signal with the last seismic source of the survey.

Advantageously, the steps 214 to 226 and/or the steps 214 to 220 can be repeated during the method to place additional receivers 32 and additional sources 30 whenever the processing of a dataset obtained after triggering a source 30 requires such placement.

In variant, the processing step comprises processing the seismic dataset using an illuminating algorithm.

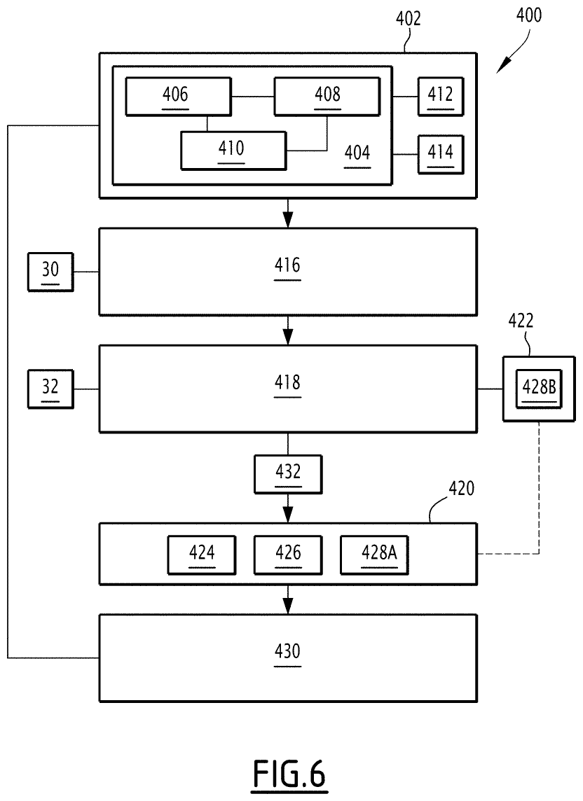

FIG. 6 schematically illustrates a system 400 for acquiring a seismic dataset over a region of interest 10, according to the invention.

The system 400 comprises a location defining unit 402 for defining a geometry of acquisition of a seismic dataset by specifying a location of a plurality of seismic sources 30 configured to induce a seismic signal in the ground, and by specifying a location of a plurality of seismic receivers 32 configured to measure ground vibrations induced by the seismic sources 30.

Typically, the location defining unit 402 comprises a calculator 404. The calculator comprises a database 406 to store the results provided by the calculator 404, a processor 408 and a memory 410 receiving at least one software module.

For example, the software module is able to carry out an optimization method for optimizing the location of the plurality of seismic sources 30 and of the plurality of seismic receivers 32 based on for example both the quality of the expected seismic survey and health, safety and environment constraints.

The location defining unit 402 also comprises a display unit 412 connected to the calculator 404 to display the results provided by the calculator 404 and a man-machine interface 414.

The system 400 further comprises a seismic signal inducing unit 416 for inducing a seismic signal with at least one first seismic source 30 of the plurality of seismic sources 30.

The seismic signal inducing unit 416 is connected to the plurality of sources 30, advantageously by means of a wireless system.

The seismic signal inducing unit 416 is typically configured to induce a seismic signal with the sources 30 according to a sequence of acquisition, i.e. the order in which the sources 30 induce the seismic signal.

The system 400 also includes a measuring unit 418 for measuring the corresponding ground vibrations induced by the at least one first seismic source 30 with the plurality of seismic receivers 32 to obtain a seismic dataset.

The measuring unit 418 is connected to the plurality of seismic receivers 32.

The system 400 comprises a processing unit 420, 422 for processing the seismic dataset.

Advantageously, the processing unit 420 comprises a quality index calculating subunit 424 for calculating quality index based on a quality control of the seismic dataset.

The processing unit 420 may comprise a pre-processing subunit 426 for pre-processing the QC seismic dataset.

The processing unit 420 may also comprise an imaging subunit 428A for obtaining at least a basic image of the underground of the region of interest 10 with a seismic imaging algorithm.

Typically, the system comprises two processing units 420, 422.

A first processing unit 420 is located on the field, for example in a base camp 34 and/or in the main camp 39, advantageously to carry out processing which does not require high computing resources, for example with a first imaging algorithm.

A second processing unit 422 is for example located remotely, for example in a data processing center, advantageously to carry out processing which requires higher computing resources, for example with a second imaging algorithm.

In a variant, the second processing unit 422 is located in the main camp 39.

For example, the second processing unit 422 comprises only an imaging subunit 428B.

Advantageously, both first and second processing units 420, 422 are able to communicate and to share the QC seismic dataset and/or the preprocessed seismic dataset.

Advantageously, the first processing unit 420 is able to communicate the results obtained with the first imaging algorithm to the second processing unit 422.

Typically, both processing units 420, 422 are configured for carrying out the processing of the seismic dataset in a characteristic time delay after having induced a seismic signal with the last seismic source of the recording phase 201.

The characteristic time delay is preferably less than one week, still preferably less than one day, still preferably less than six hours, still preferably less than one hour.

The system 400 further comprises a unit 430 for modifying the geometry of acquisition of the seismic dataset by specifying a location of at least an additional seismic source 30 and/or a location of at least an additional seismic receiver 32, based on analyzing the processed seismic dataset.

The unit 430 for modifying the geometry of acquisition is typically connected to the location defining unit.

Advantageously, the system 400 comprises a real-time transmitting unit 432 for transmitting the ground vibrations measurements to a base camp 34 located in the region of interest 10, using at least one communication antenna 41, 43 installed in the region of interest 10.

The method according to the invention allows ensuring a high level of data quality for the seismic survey by processing progressively the seismic dataset during the acquisition. The method allows reactivity by adapting the geometry of acquisition during the acquisition of the survey if required and consequently optimizing the acquisition of the seismic survey to obtain a good quality image of the subsurface at the end of the survey.

Preferably, after the demobilization, the first seismic dataset and the or each second seismic dataset are merged into a global dataset, the method further comprising processing the global dataset after the demobilization.

The global dataset is for example processed using a full waveform inversion algorithm for obtaining a global image of the underground of the region of interest.

Advantageously, the global image presents a higher resolution and/or accuracy compared to the or each basic images obtained during the seismic survey.

The global image is for example used for defining drilling targets.

In a variant, both first and second processing units 420, 422 may also be able to communicate and to share the raw seismic dataset.

Advantageously, the transfer between the first processing unit 420 and the second unit processing 422 may be in one way or in two-way.

Preferably, the first processing unit 420 is located in the region of interest or in the vicinity of the region of interest, for example at a distance of less than 10 km from the region interest. The second processing unit 422 is advantageously located remotely from the region of interest or the vicinity of the region of interest, for example at a distance greater than 10 km from the area of interest.

1. A method for acquiring a ground seismic dataset over a region of interest, said method comprising the following steps:
defining a geometry of acquisition of the seismic dataset specifying a location of a plurality of seismic sources and a location of a plurality of seismic receivers,
inducing a seismic signal with at least one first seismic source of the plurality of seismic sources,
measuring the corresponding ground vibrations induced by the at least one first seismic source with the plurality of seismic receivers to obtain a first seismic dataset,
processing the first seismic dataset,
modifying the geometry of acquisition of the first seismic dataset by specifying a location of at least an additional seismic source and/or a location of at least an additional seismic receiver, based on analyzing the processed first seismic dataset,
placing the additional seismic source at the specified location, inducing a seismic signal with the additional seismic source, measuring the corresponding ground vibrations with the plurality of seismic receivers to obtain at least one second seismic dataset, and/or placing the additional seismic receiver at the specified location, inducing a seismic signal with a seismic source, measuring the corresponding ground vibrations with a plurality of seismic receivers including the additional seismic receiver to obtain a second seismic dataset, and
processing the first seismic dataset and the at least one second dataset together to obtain at least an updated processed image of the underground of the region of interest.

2. The method according to claim 1, wherein the processing step comprises calculating a quality index based on a quality control of the first seismic dataset and/or obtaining at least a basic image of the underground of the region of interest with an seismic imaging algorithm using the processed first seismic dataset.

3. The method according to claim 2, wherein the seismic imaging algorithm is a pre-stack time migration algorithm or a pre-stack depth migration.

4. (canceled)

5. (canceled)

6. (canceled)

7. The method according to claim 1, wherein the step of processing the first seismic dataset and/or the second seismic dataset is carried out before the demobilization of the seismic survey.

8. The method according to claim 1, wherein the first seismic dataset and the or each second seismic dataset are merged into a global dataset, the method further comprising processing the global dataset after the demobilization.

9. The method according to claim 8, wherein the global dataset is processed using a full waveform inversion algorithm for obtaining a global image of the underground of the region of interest.

10. The method according to claim 1, wherein the step of processing the first seismic dataset and/or the second seismic dataset is carried out in a characteristic time delay after having induced a seismic signal with the last seismic source of the corresponding first and/or second dataset.

11. The method according to claim 1, comprising, prior to the processing step, inducing a seismic signal with at least a second seismic source of the plurality of seismic sources and measuring the corresponding ground vibrations induced by the at least second seismic source with the plurality of seismic receivers of the plurality of receivers, the first dataset including data measured from the ground vibrations induced by the first seismic source and induced by the second seismic source.

12. The method according to claim 1, further comprising transmitting in real-time the ground vibrations measurements to a base camp located in the region of interest, using at least one communication antenna installed in the region of interest.

13. The method according to claim 1, comprising transporting the at least one additional seismic receiver at their respective specified location using an airborne vehicle.

14. A system for ground acquiring a seismic dataset over a region of interest, said system comprising:
a location defining unit defining a geometry of acquisition of a seismic dataset by specifying a location of a plurality of seismic sources configured to induce a seismic signal in the ground, and by specifying a location of a plurality of seismic receivers configured to measure ground vibrations induced by the seismic sources,
a seismic signal inducing unit inducing a seismic signal with at least one first seismic source of the plurality of seismic sources, and/or with at least one additional seismic source,
a measuring unit receiving measurements of the corresponding ground vibrations induced by the at least one first seismic source with the plurality of seismic receivers to obtain a first seismic dataset, and
receiving measurements of the corresponding ground vibrations induced by the at least one additional seismic source with the plurality of seismic receivers and/or the corresponding vibrations induced by a seismic source with the plurality of seismic receivers including the at least one additional seismic receiver,
said measurements forming a second seismic dataset,
a processing unit processing the first and the second seismic datasets together, and
a unit modifying the geometry of acquisition of the seismic dataset by specifying a location of the at least an additional seismic source and/or a location of the at least an additional seismic receiver, based on analyzing the first processed seismic dataset.

15. The system according to claim 14, wherein the processing unit comprises a quality index calculating subunit calculating quality index based on a quality control of the first dataset, and/or an imaging subunit obtaining at least a basic image of the underground of the region of interest with an seismic imaging algorithm.

16. The system according to claim 14, further comprising a real-time transmitting unit transmitting the ground vibrations measurements to a base camp located in the region of interest, using at least one communication antenna installed in the region of interest.

17. The system according to claim 14, wherein the processing unit is configured for carrying out the processing of the seismic dataset in a characteristic time delay after having induced a seismic signal with the last seismic source of the seismic dataset.

18. A computer program product comprising instructions, which when the program is executed by a computer, implements the following steps:
defining a geometry of acquisition of a ground seismic dataset specifying a location of a plurality of seismic sources and a location of a plurality of seismic receivers,
acquiring a first seismic dataset obtained from measuring ground vibrations induced by at least one first seismic source with a plurality of seismic receivers, the seismic source inducing a seismic signal,
processing the first seismic dataset,
modifying the geometry of acquisition of the first seismic dataset by specifying a location of at least an additional seismic source and/or a location of at least an additional seismic receiver, based on analyzing the processed first seismic dataset,
acquiring a second seismic dataset obtained from measuring ground vibrations induced by the at least one additional seismic source with the plurality of seismic receivers and/or obtained from measuring ground vibrations induced by a source with the plurality of seismic receivers including the at least one additional seismic receiver, and
processing the first seismic dataset and the at least one second dataset together to obtain at least an updated processed image of the underground of the region of interest.

19. The computer program product according to claim 18, comprising program code to one way or two-way transfer, the raw seismic dataset and/or the quality control processed seismic dataset and/or the preprocessed seismic dataset between a first processing unit located in the region of interest or in the vicinity of the region of interest, and a second processing unit located remotely from the region of interest or the vicinity of the region of interest.

20. The method according to claim 7, wherein the step of processing is carried out before inducing a seismic signal with the last seismic source of the survey.

21. The computer program according to claim 18, wherein the processing step comprises calculating a quality index based on a quality control of the first seismic dataset and/or obtaining at least a basic image of the underground of the region of interest with a seismic imaging algorithm using the processed first seismic dataset.
